(19) United States
(12) Patent Application Publication
(10) Pub. No.: US 2006/0085358 A1
(43) Pub. Date: Apr. 20, 2006

(54) System and method for creating and ordering gift certificates via an interactive medium

(76) Inventors: James Blouzard, Brooklyn, NY (US); Bertile Burel, Brooklyn, NY (US)

Correspondence Address: Jacques Blouzard, Apt. 2, 238 6th Avenue, Brooklyn, NY, 11215, US

(21) Appl. No.: 10/969,585

(22) Filed: Oct. 20, 2004

(51) Int. Cl. G06F 17/60

(52) U.S. Cl. 705/65

(57) ABSTRACT

The present invention discloses a system and method for creating and ordering customizable gifts and/or gift certificates via an interactive medium such as the internet. To utilize the system of the present invention, a person first visits a specific internet address and logs in using his/her username and password. The user then utilizes the website applet to choose the type of gift recipient. The user is then prompted to browse by price range, gift category, item search, etc. Once the user has made a selection, the website applet queries a gift database and returns the selections to the user. The user then customizes the gift selection by selecting packaging and other options. Other gift certificates also be purchased and customized during the same log-in session. A transaction system is then utilized to complete the user's order. Each gift certificate is then packaged in an aesthetically pleasing box and mailed to the gift recipient.

### FIELD OF THE INVENTION

The present invention generally relates to the field of creating and ordering unique gifts. More particularly, the present invention provides a system and method for creating unique gift certificates and packages for users via the Internet.

### BACKGROUND OF THE INVENTION

The most traditional way of acquiring a gift certificate for a person is to physically visit a store and make a purchase. Generally, the gift certificate can only be used at the store at which the gift certificate was purchased. As a result, the gift recipient can only use the gift certificate at a few particular locations. This may be inconvenient for the gift recipient especially if he/she does not live or work in proximity to one of the store's locations.

To alleviate some of the inconveniences associated with traditional gift certificates, some companies and organizations offer gift certificates which may be utilized at a plurality of different stores. For example, some malls offer gift certificates which allow a recipient to user the gift certificate at any store in the mall. This method of issuing gift certificates has the advantage that the money can be used at a variety of stores. However, these gift certificates can usually only be purchased in the mall or at a store and are rarely available online.

Gift certificates may also be purchased for redeemable services such as spa treatments, massages, gym memberships, sports lessons, etc. Like traditional monetary gift certificates, these are usually only available for purchase directly from the participating store or merchant and often even have expiration dates. In addition, these types of gift certificates can usually only be utilized for very specific services provided by the store/merchant from which it was purchased.

Gift Certificates are Also

Therefore, there clearly exists a need for a gift certificate which may be utilized for a variety of services and which is easily obtained. The gift certificate should allow a person to purchase and customize the gift certificate using a commonly available medium such as the telephone network or the Internet.

### BRIEF SUMMARY OF THE INVENTION

The present invention discloses a system and method for creating and ordering customizable gifts and/or gift certificates via an interactive medium such as the internet. The gift certificates which are created by the present invention have the advantage that they can be utilized for a variety of gifts and services. For example, a gift recipient could use his/her gift certificate created by the present invention to purchase beauty products and also receive a massage. As another example, a gift recipient may utilize a customized gift certificate to purchase skiing equipment and to obtain lessons. The gift recipient may utilize the gift certificate at any of the vendors indicated on the gift certificate until the monetary value of the gift certificate has been depleted.

In the preferred embodiment of the present invention, the created gift certificates are packaged in an aesthetically pleasing container, such as a gift box. Each gift certificate arrives to the gift recipient in a completely customizable gift box. Preferably, the gift box contains information on how to redeem the gift certificate and other information such as displays showing where the included gift certificate may be utilized. For example, one side of the gift box may contain instructions while the other three sides contain pictures showing different products and services for which the included gift certificate may be utilized.

To utilize the system of the present invention, a person first visits a specific internet address which the user will utilize to create the gift(s). In the preferred embodiment of the present invention, the user must log-in to the website to ensure a secure transaction.

Once the user has logged-in, the user must first choose the type of recipient to which the gift package is to be given. Different types of recipients may include, but are not limited to, a wife, a husband, a mother, a father, a couple, etc. After the user has selected the type of recipient, the user must select a price range for the gift certificate, select a gift category (e.g., spa packages, massages, lessons, vacations, etc.), or search the available gift certificates for specific terms. If a user selects a price range, the website applet queries a gift database and displays the results to the user. The user then selects the desired gift package from the displayed results.

Similarly, if a user selects a gift category after choosing the gift recipient, the website applet queries the gift database and displays the results to the user separated by price range. The user then selects the desired gift package from the displayed results.

If a user chooses to search the gift certificates, the website applet will query a gift database and return all available gift certificates which satisfy the user's request. The different categories which a user may search include, but are not limited to, a price range, the type of gift recipient, different keyword(s), etc. Based upon the programming of the website applet, the results will either be displayed to the user by price range or by category. The user then selects the desired gift package from the displayed results.

The user then selects the desired gift package from the displayed results. That is, each gift certificate purchased via the website may be utilized at a variety of retailers and merchants. For example, if a gift certificate for a “spa treatment” is purchased, the gift recipient may utilize the gift certificate at a variety of different spas. In this scenario, it is highly likely that one of the spas will be in close proximity to the gift recipient and the gift certificate is more likely to be redeemed.

Optionally, the user may select any number of gift certificates which have the same inherent monetary value. For example, if a search returned four gift certificates which all had the same monetary value, the user could select all four options to be included on the same gift certificate. Then, when the user presents the gift certificate to the gift recipient, the gift recipient could select from the four options.

At this point, the user may also customize the gift by selecting the packaging desired, adding a note, selecting a delivery method, adding physical items to the package, etc. For example, if a user has selected a “spa treatment” gift certificate, the user may be provided with options to add skin care or other products (e.g., aromatherapy items, scented candles, loofa sponges, etc.) to the packaging of the item. Once the user has completely customized their gift certificate(s), the user completes the transaction using an internet transaction system. The gift certificate in its selected packaging will then eventually be delivered to the gift recipient on the selected date.

Therefore, it is an object of the present invention to provide a system and method for issuing a gift certificate which is easy to purchase and is redeemable at a variety of merchants and retailers.

Another object of the present invention is to provide a system and method for issuing gift certificates via the internet.

An additional object of the present invention is to provide a system and method for issuing a gift certificate which provides a plurality of different types of gift certificates which cater to a wide variety of different potential gift recipients.

Yet another object of the present invention is to provide a system and method for issuing a gift certificate in a customizable and aesthetically pleasing package.

Other objects, features, and characteristics of the present invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE DRAWINGS

For a more complete understanding of the present invention, reference is now made to the following drawings in which:

FIG. 1 depicts a schematic diagram of the hardware setup required for the preferred embodiment of the present invention.

FIG. 2 depicts a flowchart showing the steps utilized by the website applet in assisting a user choosing a gift certificate.

### DETAILED DESCRIPTION OF THE INVENTION

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative.

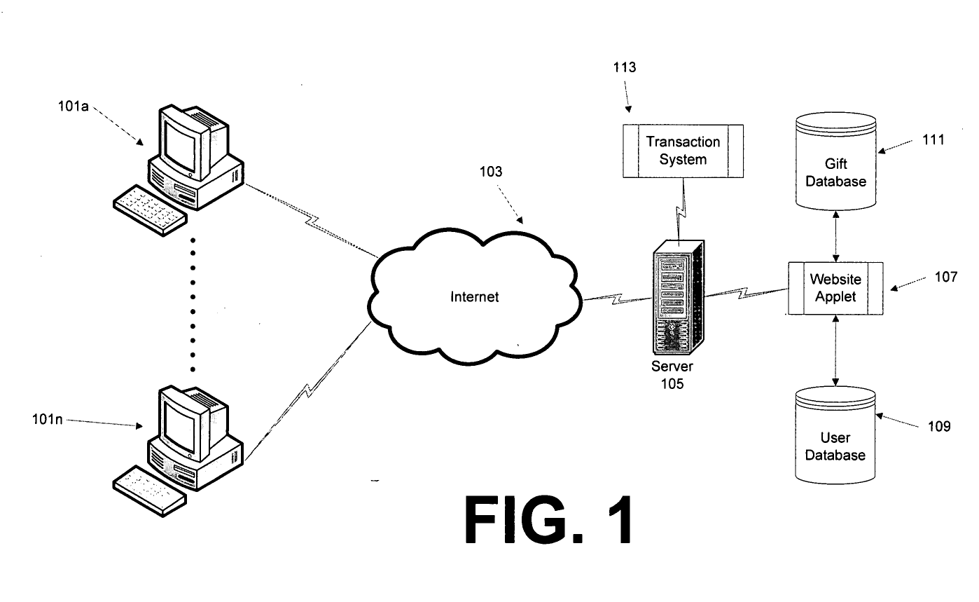

The present invention discloses a system and method for creating and ordering customizable gifts and/or gift certificates via an interactive medium such as the internet. With reference first to FIG. 1, shown is a network diagram depicting a typical network layout compatible with the system of the present invention. Each user of the system utilizes workstation 101a to 101n connected to Internet 103.

The application which controls the system of the present invention resides on server 105 which is connected to Internet 103. Server 105 contains website applet 107, user database 109, gift database 111, and transaction system 113. Website applet 107 authenticates users utilizing user database 109 and guides the user through the steps of purchasing a gift certificate(s) utilizing gift database 111. Transaction system 113 is utilized to allow a person to complete an online payment once the gift certificate(s) have been selected and properly customized.

Any merchant may register to be included in gift database 111. Different methods for registering merchants may be utilized with the present invention. For example, server 105 may contain a registration applet by which different merchants may register their products and services. It should be obvious to one skilled in the art how such a registration applet could be constructed.

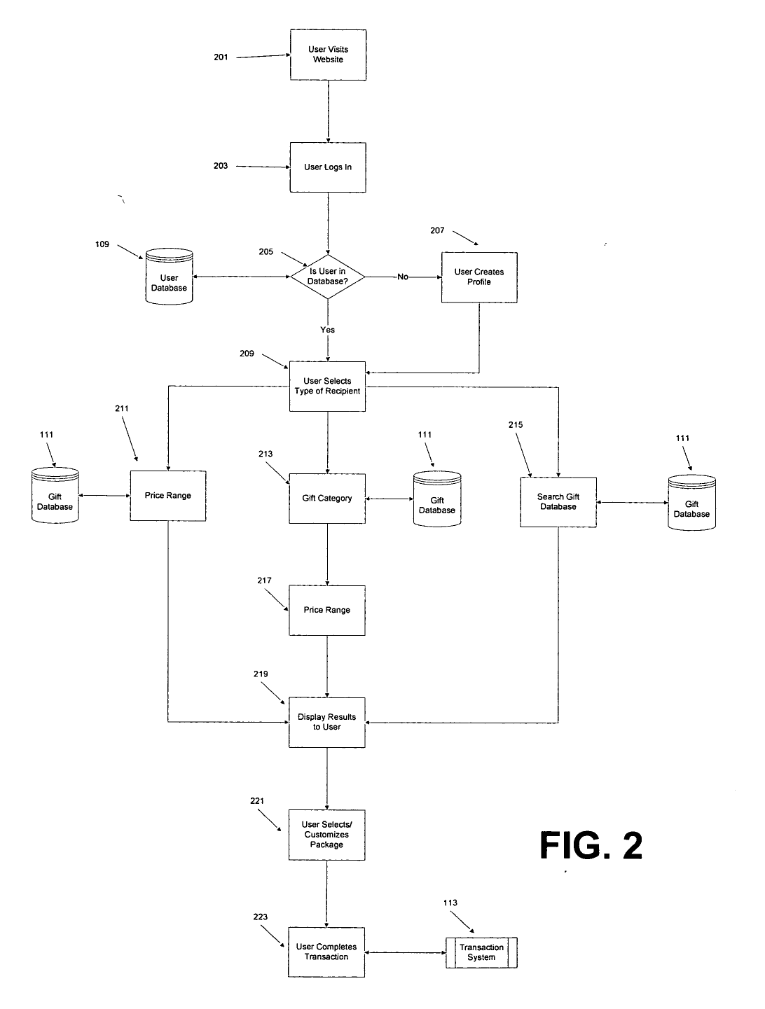

Referring next to FIG. 2, shown is the flowchart of steps utilized by website applet 107 to guide the user through the step of purchasing one or more gift certificates. First, a user utilizes one of user workstations 101a to 101n to access website applet 107 which resides on server 105 in step 201. The user will utilize website applet 107 to create the gift certificate(s). In the preferred embodiment of the present invention, the user must log-in to the website in step 203 to ensure a secure transaction. After a user has entered his/her username and password, website applet 107 queries user database 109 in step 205 to authenticate the user. If the user's information is not found in user database 109, the user is prompted to create a new profile in step 207. Afterwards, the user is allowed to proceed to step 209.

If a user is authenticated in step 207, the user also proceeds to step 209 wherein the user must choose the type of recipient that is going to receive the gift certificate. Different types of recipients may include, but are not limited to, a wife, a husband, a mother, a father, a couple, etc. After the user has selected the type of recipient, the user must select a price range for the gift certificate in step 211, select a gift category (e.g., spa packages, massages, lessons, vacations, etc.) in step 213, or search the available gift certificates for specific terms in step 215. If a user selects a price range in step 211, website applet 107 queries gift database 111 and displays the results to the user in step 219. The user then selects the desired gift package from the displayed results.

Similarly, if a user selects a gift category in step 213 after choosing the gift recipient, website applet 107 queries the gift database and displays the results to the user separated by price range in step 217. The user then selects the desired gift package from the displayed results in step 219.

In the preferred embodiment of the present invention, the created gift certificates are packaged in an aesthetically pleasing container, such as a gift box. Each gift certificate arrives to the gift recipient in a completely customizable gift box. Preferably, the gift box contains information on how to redeem the gift certificate and other information such as displays showing where the included gift certificate may be utilized. For example, one side of the gift box may contain instructions while the other three sides contain pictures showing different products and services for which the included gift certificate may be utilized.

If a user chooses to search the gift database in step 215, website applet 107 will query gift database 111 and return all available gift certificates which satisfy the user's request. The different categories which a user may search include, but are not limited to, a price range, the type of gift recipient, different keyword(s), etc. Based upon the programming of website applet 107, the results will either be displayed to the user by price range or by category. The user then selects the desired gift package from the displayed results in step 219.

Preferably, each gift certificate purchased via the website may be utilized at a variety of retailers and merchants. For example, if a gift certificate for a “spa treatment” is purchased, the gift recipient may utilize the gift certificate at a variety of different spas. In this scenario, it is highly likely that one of the spas will be in close proximity to the gift recipient and the gift certificate is more likely to be redeemed.

Optionally, the user may select any number of gift certificates which have the same inherent monetary value. For example, if a search returned four gift certificates which all had the same monetary value, the user could select all four options to be included on the same gift certificate. Then, when the user presents the gift certificate to the gift recipient, the gift recipient could select from the four options.

The user may also customize the gift in step 221 by selecting the packaging desired, adding a note, selecting a delivery method, adding physical items to the package, etc. For example, if a user has selected a “spa treatment” gift certificate, the user may be provided with options to add skin care or other products (e.g., aromatherapy items, scented candles, loofa sponges, etc.) to the packaging of the item. Once the user has completely customized his/her gift certificate(s) in step 221, the user completes the transaction in step 223 using transaction system 113. Transaction system 113 is preferably a standard applet utilized by e-commerce websites to process online credit card and/or checking transactions. However, it should be obvious to one skilled in the art that transaction system 113 may be any system which is capable of processing an online monetary event.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

We claim:

1. A method for issuing gift certificates via an interactive medium comprising the steps of:
visiting a website via the internet;
logging into said website using personal identification information;
transmitting said personal identification information to a server;
authenticating said personal identification information utilizing information stored in a user database on said server;
selecting a type of gift recipient for said gift certificate;
selecting said gift certificate from a plurality of gift certificates located in a gift database;
displaying the results of said selection step;
selecting customized packaging for said gift certificate; and
completing the financial transaction for said gift certificate utilizing a transaction system.

2. A method for issuing gift certificates via an interactive medium according to claim 1, wherein said personal identification information is at least one from the group consisting of a user name, a password, a personal identification number, a social security number, a first name, a last name, a zip code, and an area code.

3. A method for issuing gift certificates via an interactive medium according to claim 1, wherein said personal identification information is transmitted to said server via the Internet.

4. A method for issuing gift certificates via an interactive medium according to claim 1, wherein a web applet located on said server performs the steps of selecting a type of gift recipient for said gift certificate;
selecting the type of said gift certificate utilizing a gift database;
displaying the results of said selection step to the user; and
selecting customized packaging for said gift certificate.

5. A method for issuing gift certificates via an interactive medium according to claim 1, wherein said type of gift recipient is at least one from the list consisting of a wife, a husband, a mother, a father, a couple, a grandparent, an aunt, an uncle, a significant other, and a friend.

6. A method for issuing gift certificates via an interactive medium according to claim 1, wherein said type of gift certificate is at least one from the list consisting of travel, vacation, spa services, sports lessons, spa services, and product purchases.

7. A method for issuing gift certificates via an interactive medium according to claim 1, wherein said step of selecting said gift certificate from said gift database is performed utilizing the steps of:
selecting a gift category for said gift certificate; and
selecting a price range for said gift certificate.

8. A method for issuing gift certificates via an interactive medium according to claim 1, wherein said step of selecting said gift certificate from said gift database is performed utilizing the step of:
selecting a price range for said gift certificate.

9. A method for issuing gift certificates via an interactive medium according to claim 1, wherein said step of selecting said gift certificate from said gift database is performed utilizing the step of:
querying said gift database utilizing search information provided by said user.

9. A method for issuing gift certificates via an interactive medium according to claim 9, wherein said search information is at least one from the list consisting of a type of gift recipient, a type of gift certificate, a keyword, a price, and a price range.

10. A method for issuing gift certificates via an interactive medium according to claim 1, wherein said step of selecting customized packaging;
selecting the type of packaging desired;
adding a note to said gift certificate;
selecting a delivery method; and
adding physical items to be included with said customized packaging.

11. A method for issuing gift certificates via an interactive medium according to claim 10, wherein said physical items are related to the type of gift certificate.

12. A method for issuing gift certificates via an interactive medium according to claim 1, wherein said user may combine a plurality of gift certificates from said gift database into a single gift certificate, wherein a gift recipient selects one gift certificate from the plurality of gift certificates after receiving said gift certificate.
